(19) United States
(12) Patent Application Publication
(10) Pub. No.: US 2016/0161441 A1
(43) Pub. Date: Jun. 9, 2016

(54) GAS SENSOR ELEMENT

(71) Applicants: Werner Reiter, Klosterneuburg (AT); Peter Klaus Soukup, Klosterneuburg (AT)

(72) Inventors: Werner Reiter, Klosterneuburg (AT); Peter Seyr, Klosterneuburg (AT)

(73) Assignees: Werner Reiter, Klosterneuburg (AT); Peter Klaus Soukup, Klosterneuburg (AT)

(21) Appl. No.: 14/962,219

(22) Filed: Dec. 8, 2015

(30) Foreign Application Priority Data
Dec. 8, 2014 (DE) 102014118153.0

(51) Int. Cl. G01N 27/40; G01N 27/407

(52) U.S. Cl. CPC G01N 27/40; G01N 27/4077; G01N 27/4073; G01N 27/4076

(57) ABSTRACT

A gas sensor is described comprising a solid electrolytic cell having at least one solid electrolyte and at least two electrodes, disposed on opposite surfaces of the solid electrolyte, namely a reference electrode and a measurement electrode. The reference electrode is disposed in a reference chamber. At least part of a wall of the reference chamber is formed by a heating element comprising a ceramic substrate. The measurement electrode is disposed in a measurement chamber containing the sample gas. At least part of a wall of the measurement chamber comprises a fine filter for separation of pollutant gases from the sample gas and the measurement chamber is otherwise sealed off in a gastight manner. The fine filter, the solid electrolyte and the ceramic substrate of the heating element are disposed one above the other in the form of a sandwich structure and connected to one another by connecting elements.

### CROSS-REFERENCE TO RELATED APPLICATIONS

This application claims the benefit of German Patent Application No. 10 2014 118 153.0, filed Dec. 8, 2014, the disclosure of which is hereby incorporated herein in its entirety by reference.

### TECHNICAL FIELD

The invention relates to a gas sensor element.

### BACKGROUND

Methods and sensors for measuring the oxygen content of a sample gas exist in various designs. Known, for example, are oxygen sensors which operate according to a diffusion-limited amperometric method. However, these oxygen sensors are only suitable to a certain extent for measurement at high air humidity since moisture can penetrate into the interior of the oxygen sensor via design-related diffusion openings and can lead to problems there.

Oxygen sensors which operate according to a potentiometric method are further known. These sensors are predominantly used for measurement of low oxygen concentrations in the area of exhaust gas monitoring. By avoiding diffusion openings, these sensors are also more robust to moisture. In order to determine the oxygen content, the oxygen partial pressure of a reference gas is compared with the oxygen partial pressure of the sample gas and specifically using a solid electrolytic cell which in the simplest case consists of a first electrode in the area of the reference gas, a second electrode in the area of the sample gas and an oxygen-conducting solid electrolyte between the electrodes. The measurement voltage applied to the electrodes determines the oxygen partial pressure quotients between the reference gas and the sample gas according to the Nernst equation. However, this simplified potentiometric measuring method assumes that the oxygen partial pressure in the reference volume is constant, i.e. the reference chamber receiving the reference gas must be absolutely tightly sealed which is not achievable in practice or at most only with an economically untenable expenditure.

In addition, a plurality of other gas measurement sensors based on ion-conducting solid electrolytes are known. Zirconium dioxide (ZrO2) solid electrolytes for conducting oxygen ions are a commonly used example for such ion-conducting solid electrolytes. In order to achieve a sufficient ion conductivity, ZrO2 electrolytes are usually operated at temperatures above 400° C. The interface between solid electrolyte and gas consists of an electrode at which gas molecules are ionized. The aim of the electrode is to set up a so-called three-phase boundary consisting of solid electrolyte, electrode metal and gas. An electrode surface as large as possible is advantageous, i.e. the electrode is usually designed to be porous. A known problem of these systems is the functional impairment by pollutants, in particular pollutant gases which impede the transfer of the gas molecules or gas ions at the electrode.

An example of such pollutant gases are silanes, i.e. silicon-hydrogen compounds which possibly evaporate from silicone seals. At the heated electrode, the silanes cause a permanent reduction of the activity by chemical absorption of the silicon compounds directly at the electrode or as a result of a silicone dioxide (SiO2) vitrification of the electrode pore structure. There are a number of other substances which can act in a similar manner as electrode poison such as, for example, sulphur compounds which present a problem for gas measurements in exhaust gases. The electrode adverse effects caused by such pollutant gases are only partially reversible so that the damage adds up and thus can result in a premature failure of the gas measurement sensor.

In order to solve these problems, a number of devices are known from the prior art which offer at least partial protection from pollutant gases. In principle, these involve filters which are connected upstream of the measurement system. Frequently the filters are also used as protection from liquid droplets or from particles which are entrained by the gas flow.

Known from DE 10 2008 000 463 A1 (also published as U.S. Pat. No. 8,176,767) is a device on which the side of the sensor facing the exhaust gas is surrounded by a protective tube and is additionally protected by a porous storage medium. The protective tube has openings for the gas exchange. The aim of the device is that possible sulphur, phosphorus or silicon compounds are stored irreversibly in the storage medium.

Known from DE 10 2008 041 795 A1 is a device in which the gas sensor element is directly covered with a porous protective layer, i.e. the protective layer is also directly heated by the gas sensor element.

A typical problem of these known solutions is that filters or protective layers having sufficient protective effect vitrify of their own volition with time so that in extreme cases no more gas exchange can take place. In order to stabilize the long-term filter effect, according to DE 10 2008 041 795 A1 a plurality of filter layers are applied where particle and pore size of the filter layers increase towards the outside. According to DE 10 2010 042 640 A1 (also published as U.S. Patent Application Publication No. 20110089032) the multistage protective layer method is further expanded by a layer with noble metal catalyst particles.

Despite these solutions known from the prior art, the protection of gas sensors from the influence of pollutants remains a central aim of the further development of gas sensor elements.

### DESCRIPTION OF THE INVENTION

This is where the invention begins. A gas sensor element is to be provided which as a result of its design, offers improved protection from pollutant gases. Further advantageous aspects, details and embodiments of the invention are obtained from the dependent claims, the description and the drawings.

“Sample gas” in the sense of the invention is to be understood as the gas to be measured.

An “oxygen-conducting solid electrolyte” in the sense of the invention is an electrolyte which in a pumping operation upon exposure to a pump flow produces oxygen transport depending on an amount of charge carriers produced by the pump flow and in a measurement operation delivers a voltage corresponding to an oxygen partial pressure quotient between a reference gas and a sample gas.

The present invention provides a gas sensor element comprising a solid electrolytic cell having at least one solid electrolyte element and at least two electrodes disposed on mutually opposite surfaces of the solid electrolyte element, namely at least one reference electrode and at least one measurement electrode. The at least one reference electrode is disposed in a reference chamber, wherein at least a part of a wall of the reference chamber is formed by a heating element comprising a ceramic substrate. The at least one measurement electrode is disposed in a measurement chamber containing the sample gas, wherein at least a part of a wall of the measurement chamber is configured to be a fine filter for separation of pollutant gases from the sample gas and the measurement chamber is otherwise sealed off in a gastight manner with respect to the surroundings. The fine filter, the solid electrolyte element and the ceramic substrate of the heating element are disposed one above the other in the form of a sandwich structure and connected to one another by connecting elements.

As has already been described, the non-reversible deposits on the electrode are particularly critical for the sensor lifetime. As a result of the upstream fine filter according to the invention, a deposition of pollutant gases is effected on the filter instead of on the electrode. The filter therefore ensures on the one hand that a large proportion of the pollutant gas is deposited on the filter, on the other hand the filter allows sufficient quantities of the sample gas to pass through so that the measuring function of the gas sensor is maintained.

As a result of the arrangement of fine filter, solid electrolyte element and ceramic substrate of the heating element in the form of a sandwich structure, an optimization of the sensor structure can be achieved which makes an additional contribution to improvement of the filter effect. With increasing temperature, the rate of deposition of pollutant gases is increased. As a result of the compact sensor structure, the fine filter is heated by the sensor heating and therefore has a sufficiently high temperature in order to store pollutant gases irreversibly in the filter structure.

In fact, the limitation of the gas exchange caused by the upstream fine filter in principle has a negative effect on the response behaviour of the sensor. As a result of the compact sensor structure however, there is only a relative small gas volume between the filter and the sensor electrode, whereby the disadvantageous influence on the response behaviour can be minimized.

The fine filter also acts as thermal stabilization of the solid electrolytic cell and thus improves the stability of the measurement. Without the fine filter, the measurement electrode would be directly exposed to the surroundings and therefore also to the temperature fluctuations which occur there. For measurements at room temperature, a strong temperature gradient between measurement electrode and reference electrode would be obtained without filters. This temperature gradient can be reduced significantly by the fine filter.

According to a preferred embodiment, the at least one reference electrode is disposed in a reference chamber filled with reference gas, which is sealed off in a gastight manner with respect to the surroundings. As a result of the arrangement of the reference electrode in a reference chamber which is sealed off in a gastight manner with respect to the surroundings, a defined constant composition of the gas surrounding the reference electrode over the entire measurement process is achieved, whereby the measurement accuracy is increased significantly compared to open systems.

An alternative however is a gas sensor element operating on an amperometric basis, in which the reference electrode is connected to the measurement surroundings via a diffusion channel. In this case, therefore the reference chamber is not sealed off in a gastight manner with respect to the surroundings but is connected to these. For this purpose, the wall of the reference chamber which is formed by the heating element having a ceramic substrate is configured in two parts, where the addressed diffusion channel is formed between the two wall parts.

In such an amperometric gas sensor element, the solid electrolytic cell is acted upon by a bias voltage so that an oxygen ion flow is forced through the cell. The voltage polarity is selected so that preferably oxygen is pumped via the reference electrode in the direction of the measurement electrode. An oxygen concentration close to 0 vol. % is established in the reference chamber if the bias voltage of the solid electrolytic cell is sufficiently high. As a result of the gradient of the oxygen concentration between reference chamber and measurement surroundings, there is a continuous flow of oxygen gas into the reference chamber which is limited by the diffusion channel. The measured current through the electrolytic cell is proportional to the oxygen gas flow which in turn is a measure for the oxygen concentration of the measurement surroundings.

The amperometric measurement principle requires a continuous gas flow through the sensor structure and thus also results in a forced after flow of pollutant gases. This measurement principle is therefore actually not optimal for applications with elevated pollutant gas loading. This however compares with advantages of the amperometric measurement principle, in particular a better measurement accuracy and a lower gas pressure dependence so that for certain applications even with higher pollutant gas loading, it can be worthwhile to use an amperometric gas sensor element. The resistance to pollutant gases can be improved by a fine filter, preferably a fine filter with a pore size of less than 1 micrometer (μm). The fine filter is disposed adjacent to and above the surface of the ceramic substrate of the heating element not in contact with the reference chamber.

In order to influence the diffusion limitation of the amperometric measurement principle as little as possible, the gas permeability of the fine filter must be substantially greater than that of the diffusion channel. This is usually not a problem since the gas permeability of the fine filter is obtained by integration over the entire surface of the filter disk which contributes to the gas exchange, i.e. even for a very fine pore structure, a high gas permeability of the fine filter can be achieved with a sufficiently large surface area.

Preferably the at least one reference electrode and/or at least one measurement electrode comprises platinum electrodes. With the aid of platinum electrodes a particularly high measurement accuracy is achieved.

Preferably at least one coarse filter fitted with at least one diffusion opening is provided for separation of pollutant gases from the sample gas. According to a particularly preferred embodiment, the coarse filter together with the fine filter forms a pre-chamber which is otherwise sealed in a gastight manner with respect to the surroundings. In this embodiment, the coarse filter cooperates with the fine filter since pollutant gases only impinge upon the fine filter after flowing through the coarse filter and at this time are already present in a pre-purified state.

Such a two-stage filter structure of coarse filter and fine filter has particular advantages in cases in which high pollutant gas loadings must be expected. The two-stage filter structure certainly results in a slower gas exchange but this is—if at all—only a problem for measurement applications which require rapid sensor response times. A rapid response of the sensor is specifically always associated with a rapid gas exchange at the sensor electrode but is also associated with a rapid afterflow of pollutant gases. In particular in gas measurement in larger process chambers, frequently however only relative slow changes of the gas concentrations occur which is why in such cases a particularly rapid response of the gas sensor is not required. The coarse filter with diffusion opening therefore limits the afterflowing amount of pollutant gas and serves at the same time as a pollutant gas catcher. As a result of the pre-filtering via the diffusion opening, the lifetime of the fine filter is significantly increased, i.e. clogging or vitrification of the fine filter is reduced. A gas spatial volume which is partially separated from the measurement surroundings is formed between coarse filter and electrode. If the gas composition of the measurement surroundings changes, this change is passed on through the diffusion opening in a delayed manner to the electrode. The gas spatial volume should be as small as possible to keep this delay as small as possible.

Preferably the coarse filter is configured as a closely sintered or as a porous sintered ceramic substrate, in particular as yttrium-stabilized ZrO2. Particularly preferably the diffusion opening of the coarse filter has a diameter of at least 10 μm. If the coarse filter is formed from a porous sintered ceramic, the response time of a sensor which had not yet been exposed to any pollutant gas loading is significantly faster. As the pollutant gas loading progresses, the response behaviour deteriorates. The porous surface of the coarse filter vitrifies increasingly at the measurement surroundings until the coarse filter effectively corresponds to a dense ceramic with a diffusion opening.

Preferably the diffusion opening has a conically tapering shape in the direction of the pre-chamber, wherein the diameter of the diffusion opening in the region adjacent to the pre-chamber is at least 10 μm.

According to a further preferred embodiment, a plurality of diffusion openings are provided in the coarse filter. The number and diameter of the diffusion openings can be adapted to the type and quantity of pollutant gas to be filtered.

Preferably the solid electrolyte element is formed from an oxygen-conducting solid electrolyte, in particular yttrium-stabilized ZrO2. Particularly preferably the reference gas is oxygen. The oxygen content in a sample gas can be measured with particularly high accuracy if an oxygen-conducting solid electrolyte and oxygen as the reference gas are used. Yttrium-stabilized ZrO2 has proved particularly successful as the solid electrolyte.

According to a further preferred embodiment, a surface of the ceramic substrate of the heating element not in contact with the reference chamber is provided with a glass layer where at least one printed platinum heater is disposed on the glass layer. Particularly preferably the ceramic substrate of the heating element is formed from yttrium-stabilized ZrO2. With the aid of said embodiments, a particularly efficient, stable heating process which is not very liable to breakdown can be implemented for the gas sensor element. In particular, the particularly advantageous sensor temperatures for measurements with a gas sensor element according to the present invention between 500° C. and 600° C. can be achieved. In principle however, the sensor temperature should be selected to be as low as possible. The gas sensor according to the invention allows a reduction of the sensor temperature to a minimum of 500° C.

Preferably the temperature of the gas mixture to be measured is between 20° C. and 300° C. Equally preferably the gas mixture to be measured is located in a process chamber having a volume of at least 100 liters.

Preferably the fine filter for separation of pollutant gases from the sample gas comprises a fine filter for separation of silanes from the sample gas.

The pollutant gases to be filtered preferably comprise silanes. This type of pollutant gas is in particular produced by the heating of silicone seal material. This involves a process in which silanes occur as undesired gas components. The concentrations of pollutant gases which occur are significantly lower than the silane concentrations produced in fabrication processes in semiconductor technology in which silanes are specifically used in high concentration for SiO2 precipitation.

Temperatures greater than 300° C. are required for irreversible precipitation of silanes on surfaces. At a sensor temperature of 500° C. to 600° C. irreversible conversion of the silanes would therefore take place principally in the region of the sensor. A silane filter at a sample gas temperature of 20° C. to 300° C. would be relatively ineffective since at less than 300° C. the silanes diffuse almost unhindered through the filter. The installation of an extra heated filter upstream of the sensor is associated with high additional expenditure. The filter is therefore advantageously heated by the sensor.

Preferably the sensor heating temperature is reduced as far as possible so that the fundamental sensor and filter function is still given but the rate of deposition of the pollutant gases and in particular the silane deposition rate is minimized.

Preferably the fine filter is configured as a porous sintered ceramic substrate, in particular made of yttrium-stabilized ZrO2.

According to a further particularly preferred embodiment of the present invention, the fine filter has a pore size of less than 1 μm.

A fine-pore filter having less than 1 μm pore opening, in particular with a filter thickness of about 0.15 millimeters (mm), brings about sufficient protection of the solid electrolyte element from pollutant gases but the fine pore openings for their part lead to a rapid vitrification of the fine filter, in particular in the presence of silanes as pollutant gases. Fine filters are therefore particularly suitable for protection against low silane loadings, e.g. for applications in which the sealing material is not or is only very rarely changed. The silicon-containing components of the seal material evaporate at higher sample gas temperatures, the silane loading decreases rapidly with continuing operation.

Applications in which the seal material is changed regularly result in significantly higher silane loadings and therefore require a further improved filter design. Preferably therefore the coarse filter for separation of pollutant gases from the sample gas is a coarse filter for separation of silanes from the sample gas. The coarse filter has at least one diffusion opening whose diameter is selected so that for the predicted silane loading over the lifetime of the gas sensor element, no complete vitrification of the diffusion opening occurs.

The diffusion opening of the coarse filter is preferably funnel-shaped, i.e. the diameter directly at the measurement surroundings is greater than on the filter inner side. This compensates for the fact that the vitrification probability directly at the measurement surroundings is the highest and additionally prevents a premature vitrification of the filter structure at this highly exposed position. The diameter of the diffusion opening is preferably dimensioned so that for the predicted loading over the lifetime of the gas sensor element, no overgrowth of the diffusion opening occurs. The permeability should be at least 50% of the original permeability on reaching the maximum lifetime.

In principle, as a result of the relatively small dimensions of the diffusion opening, it is achieved that the gas exchange is reduced. Preferably the gas exchange and thus the sensor response is reduced as far as the application allows since for lower gas exchange, the filters vitrify more slowly. The filter effect is based both on the direct capture of pollutant gas particles and also on the limitation of the gas exchange so that less pollutant gas flows into the sensor.

Particularly preferably the coarse filter, the fine filter, the solid electrolyte element and the ceramic substrate of the heating element are configured to be cylindrical and disposed one above the other in a sandwich structure.

According to a further preferred embodiment, the heating element is arranged separated from the surroundings in a gastight manner. The gas sensor element is thereby supplemented by a protection of the sensor heating. Pollutant gases can negatively influence the properties of the sensor heating. An adverse effect on the measurement system can already be obtained by a slight change in the heating resistance since the sensor temperature can also be regulated by means of this. In operation, a changed sensor temperature can result in variation of the sensor characteristic and thus reduce the measurement accuracy of the system. No gas exchange has to take place at the sensor heating, therefore it is possible to hermetically separate the heating from the surroundings with the aid of a closely sintered ceramic disk.

Preferably the connecting elements comprise glass rings. Since glass has a similar coefficient of thermal expansion to the ceramic components of the sensor element, stresses caused by temperature variations between the individual components are avoided.

Preferably, the gastight separation of the heating element from the surroundings is accomplished by a closely sintered ceramic cover element, wherein the ceramic substrate of the heating element and the ceramic cover element are connected to one another by a connecting element, in particular by a glass ring.

Preferably the ceramic substrate of the heating element, the solid electrolyte element, the fine filter, the coarse filter and the connecting elements have a similar, preferably identical coefficient of thermal expansion. Since the glass rings used as connecting elements have a similar coefficient of thermal expansion, stresses caused by temperature variations between the individual components of the gas sensor element are avoided.

In principle, the porosity of the fine filter and also of the coarse filter is determined by the sintering profile and can thus be varied in the course of manufacture over several orders of magnitude.

The present invention also comprises the use of one of the gas sensor elements described above for measurement of the oxygen partial pressure or the oxygen content in a sample gas.

Further developments, advantages and possible applications of the invention are also obtained from the following description of exemplary embodiments and from the figures. In this case, all the features which are described and/or depicted by themselves or in any combination are fundamentally the subject matter of the invention regardless of their summary in the claims or the back reference.

### BRIEF DESCRIPTION OF THE DRAWINGS

The invention will be explained in detail hereinafter with reference to exemplary embodiments in connection with the drawings. In the figures:

FIG. 1 shows a vertical cross-section through one embodiment of a gas sensor element according to the present invention;

FIG. 2 shows a vertical cross-section through a further embodiment of a gas sensor element according to the present invention;

FIG. 3 shows a vertical cross-section through a further embodiment of a gas sensor element according to the present invention;

FIG. 4 shows a vertical cross-section through a further embodiment of a gas sensor element according to the present invention.

### DETAILED DESCRIPTION OF THE PRESENT INVENTION

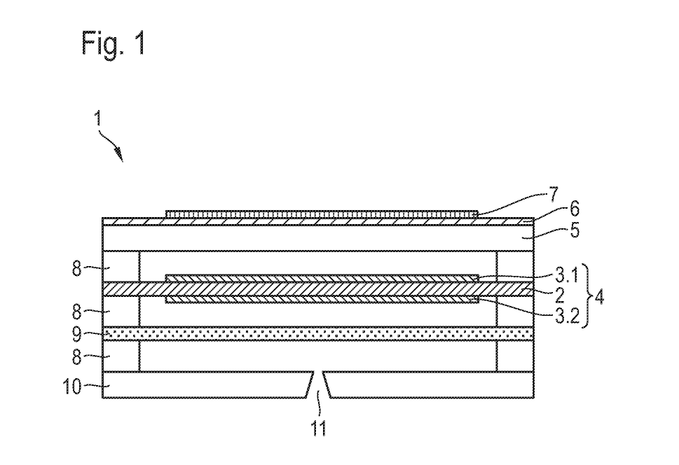

FIG. 1 shows a vertical cross-section through one embodiment of a gas sensor element 1 according to the present invention. The gas sensor element 1, which is used to determine the oxygen content of a sample gas, comprises a solid electrolytic cell 4 with an oxygen-conducting solid electrolyte element 2 and two platinum electrodes 3.1, 3.2 disposed on mutually opposite surfaces of the solid electrolyte element 2, namely a reference electrode 3.1 and a measurement electrode 3.2. In the embodiment shown, the plate-like solid electrolyte element 2 consists of closely sintered yttrium-stabilized zirconium dioxide.

The reference electrode 3.1 is located in a reference chamber which receives a reference volume, wherein at least a part of one wall of the reference chamber is formed by a heating element having a ceramic substrate 5. The at least one measurement electrode 3.2 is disposed in a measurement chamber containing the sample gas, wherein one wall of the measurement chamber is configured in the form of a fine filter 9 for separation of pollutant gases from the sample gas and the measurement chamber is otherwise sealed off in a gastight manner with respect to the surroundings. The fine filter consists of a porous sintered yttrium-stabilized zirconium dioxide and has a pore size of less than 1 μm.

An electrical heater 7 which is disposed sufficiently close to the solid electrolyte element 2 is used for heating the solid electrolyte element 2 to a constant or substantially constant operating temperature. In the embodiment shown, a printed platinum heater is used, this being disposed on the surface of the closely sintered ceramic substrate 5 of the heating element not in contact with the reference chamber on a glass layer 6 which is applied there as surface passivation. The contacting of the platinum heater can be accomplished by means of platinum (Pt) wires. Yttrium-stabilized zirconium dioxide is used as the ceramic substrate 5 of the heating element.

A coarse filter 10 fitted with a diffusion opening 11 for separation of pollutant gases from the sample gas forms together with the fine filter 9 a pre-chamber which is otherwise sealed off in a gastight manner with respect to the surroundings. The diffusion opening 11 is configured in a funnel shape, where the diameter of the diffusion opening 11 tapers in the direction of the sensor electrode to be protected. This avoids the diffusion opening 11 from closing prematurely at the particularly exposed transition to the external measurement surroundings.

The coarse filter consists of a porous sintered yttrium-stabilized zirconium dioxide and has a pore size greater than 10 μm. As a result of a pore size greater than 10 μm it is achieved that the permeability of the diffusion opening 11 for the maximum predicted pollutant gas loading only decreases to about 50% over the entire lifetime of the gas sensor element.

The ceramic elements including fine filter 9, solid electrolyte element 2, ceramic substrate 5 of the heating element and coarse filter 10 are disposed one above the other in the form of a sandwich structure and connected to one another by connecting elements 8. The mechanical connection of the ceramic elements 9, 2, 5, 10 is made by fusing by means of melt preforms which are designed as glass rings 8, which therefore serve as connecting elements 8. A hermetically sealed oxygen (O2) reference chamber between heater and solid electrolytic cell 4 is provided by the glass rings 8. Glass rings 8 are also used as connecting elements to the fine filter 9 and as connecting element to the coarse filter 10. The fusing by means of glass rings in principle results in a hermetically tightly sealed connection of the individual elements, gas exchange can then only take place via the ceramic elements having a porous design or provided with a diffusion opening.

The ceramic elements including fine filter 9, solid electrolyte element 2, ceramic substrate 5 of the heating element and coarse filter 10 are all designed as sintered ceramic disks and all consist of a uniform substrate material with the result that a uniform coefficient of thermal expansion is obtained. Since the glass rings 8 used as connecting elements also have a similar thermal coefficient of expansion, stresses caused by temperature variations between the individual components of the gas sensor element are avoided.

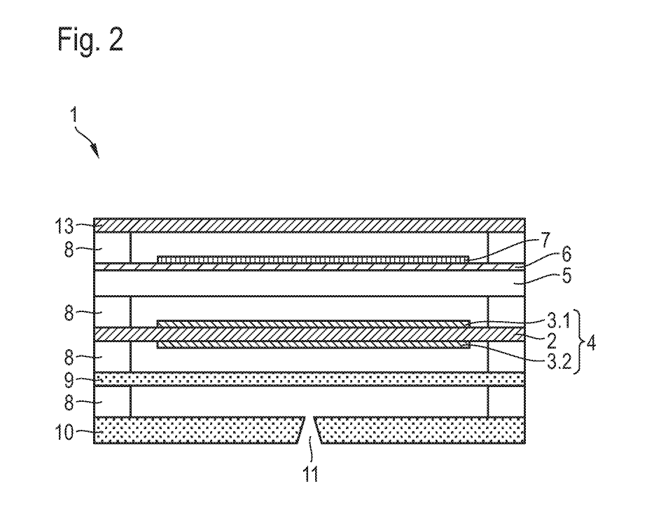

FIG. 2 shows a vertical cross-section through a further embodiment of a gas sensor element 1 according to the present invention. The gas sensor element 1 corresponds to the gas sensor element shown in FIG. 1 but additionally has a closely sintered ceramic cover element 13 which is connected by a glass ring 8 to ceramic substrate 5 of the heating element. By means of the glass ring 8 and the ceramic cover element 13, a gastight separation of the heating element from the surroundings is achieved. In this way, protection of the sensor heater is ensured and pollutant gases cannot negatively influence the properties of the sensor heater.

An adverse effect on the measurement system can already be obtained by a slight change in the heating resistance since the sensor temperature can also be regulated by means of this. In operation, a changed sensor temperature can result in variation of the sensor characteristic and thus reduce the measurement accuracy of the system. No gas exchange has to take place at the sensor heating, therefore it is possible to hermetically separate the heating from the surroundings with the aid of a closely sintered ceramic disk.

In the exemplary embodiment shown, the coarse filter 10 is formed by a porous sintered ceramic having a diffusion opening. The response time of a sensor which had not yet been exposed to any pollutant gas loading is significantly faster in this case. As the pollutant gas loading progresses, the response behaviour deteriorates. The porous surface of the coarse filter vitrifies increasingly at the measurement surroundings until the coarse filter 10 effectively corresponds to a dense ceramic with a diffusion opening as shown in FIG. 1. In this case, the pore size of the diffusion opening must naturally be greater than the pore size of the porous structure of the ceramic.

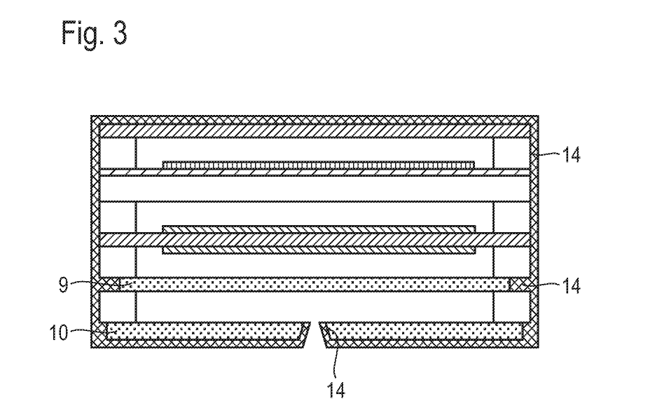

FIG. 3 shows the embodiment of FIG. 2 after a longer pollutant gas loading which leads to a severe vitrification 14 in the outer regions of the gas sensor element. The porous surface of the coarse filter 10 now corresponds to a dense ceramic with diffusion opening. The porous structure of the fine filter 9 is protected from direct contact with the measurement surroundings, gas exchange with the measurement surroundings is only obtained via the lateral surface of the fine filter disk. This is unproblematic since under silane loading this lateral surface rapidly vitrifies but the porous filter structures located further inwards are scarcely adversely affected.

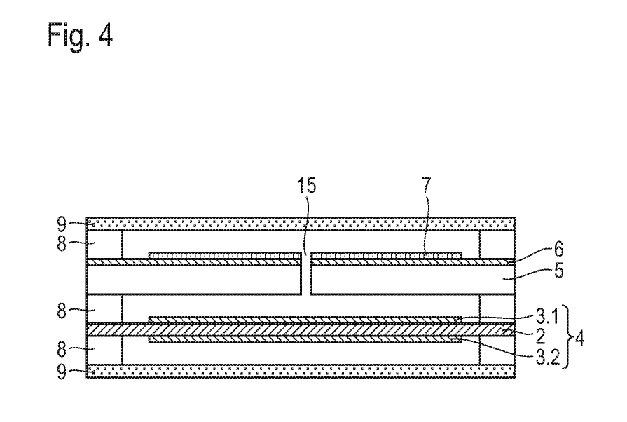

FIG. 4 shows a vertical cross-section through a further embodiment of a gas sensor element according to the present invention. The gas sensor element corresponds in large part to the gas sensor element shown in FIG. 1 but operates in the exemplary embodiment shown on an amperometric basis. The reference element 3.1 is connected via a diffusion channel 15 to the measurement surroundings. In this case therefore the reference chamber is not sealed off in a gastight manner with respect to the surroundings but is connected to these. To this end, the wall of the reference chamber formed by the heating element comprising a ceramic substrate 5 is formed in two parts, where the addressed diffusion channel 15 is formed between the two wall parts. The diffusion channel 15 enables the continuous gas flow through the sensor structure required for the amperometric measurement principle and therefore also result in a forced afterflow of pollutant gases. In order to increase the resistance to these pollutant gases, an additional fine filter 9 having a pore size less than 1 μm is provided. The fine filter 9 is located adjacent to and above the surface of the ceramic substrate 5 of the heating element not in contact with the reference chamber and is connected to this by a glass ring 8. The gas sensor element operating on an amperometric basis thus has two fine filters 9 in the sensor sandwich structure which is provided on the opposite sides of the solid electrolytic cell so that both electrodes 3.1, 3.2 are protected from pollutant gases.

### REFERENCE LIST

1 Gas sensor element
2 Solid electrolyte element
3.1 Reference electrode
3.2 Measurement electrode
4 Solid electrolytic cell
5 Ceramic substrate
6 Glass layer
7 Platinum heater
8 Connecting element
9 Fine filter
10 Coarse filter
11 Diffusion opening
13 Ceramic cover element
14 Vitrified outer regions
15 Diffusion channel

What is claimed is:

1. Gas sensor element comprising a solid electrolytic cell having at least one solid electrolyte element and at least two electrodes disposed on mutually opposite surfaces of the solid electrolyte element, namely at least one reference electrode and at least one measurement electrode, wherein the at least one reference electrode is disposed in a reference chamber, wherein at least a part of a wall of the reference chamber is formed by a heating element comprising a ceramic substrate, wherein the at least one measurement electrode is disposed in a measurement chamber containing the sample gas, wherein at least a part of a wall of the measurement chamber is configured in the form of a fine filter for separation of pollutant gases from the sample gas and the measurement chamber is otherwise sealed off in a gastight manner with respect to the surroundings, wherein the fine filter, the solid electrolyte element and the ceramic substrate of the heating element are disposed one above the other in the form of a sandwich structure and connected to one another by connecting elements.

2. The gas sensor element according to claim 1, wherein the at least one reference electrode is disposed in a reference chamber filled with reference gas, which is sealed off in a gastight manner with respect to the surroundings.

3. The gas sensor element according to claim 1, wherein at least one coarse filter fitted with at least one diffusion opening is provided for separation of pollutant gases from the sample gas.

4. The gas sensor element according to claim 3, wherein the coarse filter together with the fine filter forms a pre-chamber which is otherwise sealed in a gastight manner with respect to the surroundings.

5. The gas sensor element according to claim 1, wherein the solid electrolyte element is formed from an oxygen-conducting solid electrolyte, in particular yttrium-stabilized ZrO2.

6. The gas sensor element according to claim 2, wherein the reference gas is oxygen.

7. The gas sensor element according to claim 1, wherein a surface of the ceramic substrate of the heating element not in contact with the reference chamber is provided with a glass layer and at least one printed platinum heater is disposed on the glass layer.

8. The gas sensor element according to any claim 1, wherein the ceramic substrate of the heating element is formed from yttrium-stabilized ZrO2.

9. The gas sensor element according to claim 1, wherein the fine filter is configured as a porous sintered ceramic substrate, in particular made of yttrium-stabilized ZrO2.

10. The gas sensor element according to claim 1, wherein the fine filter has a pore size of less than 1 μm.

11. The gas sensor element according to claim 3, wherein the coarse filter is configured as closely sintered or as porous sintered ceramic substrate, in particular made of yttrium-stabilized ZrO2.

12. The gas sensor element according to claim 1, wherein at least one reference electrode and/or at least one measurement electrode are platinum electrodes.

13. The gas sensor element according to claim 3, wherein the diffusion opening has a diameter of at least 10 μm.

14. The gas sensor element according to claim 3, wherein the diffusion opening has a conically tapering shape in the direction of the pre-chamber, wherein the diameter of the diffusion opening in the region adjacent to the pre-chamber is at least 10 μm.

15. The gas sensor element according claim 1, wherein the fine filter for separation of pollutant gases from the sample gas is a fine filter for separation of silanes from the sample gas.

16. The gas sensor element according to claim 3, wherein the coarse filter for separation of pollutant gases from the sample gas is a coarse filter for separation of silanes from the sample gas.

17. The gas sensor element according to claim 3, wherein the coarse filter, the fine filter, the solid electrolyte element and the ceramic substrate of the heating element are configured to be cylindrical and disposed one above the other in a sandwich structure.

18. The gas sensor element according to claim 1, wherein the connecting elements are glass rings.

19. The gas sensor element according to claim 1, wherein the heating element is arranged separated from the surroundings in a gastight manner.

20. The gas sensor element according to claim 19, wherein the gastight separation of the heating element from the surroundings is accomplished by a closely sintered ceramic cover element, wherein the ceramic substrate of the heating element and the ceramic cover element are connected to one another by a connecting element.

21. The gas sensor element according to claim 1, wherein the ceramic substrate of the heating element, the solid electrolyte element, the fine filter, the coarse filter and the connecting elements have a similar, preferably identical coefficient of thermal expansion.
